(19) United States
(12) Patent Application Publication
(10) Pub. No.: US 2023/0197300 A1
(43) Pub. Date: Jun. 22, 2023

(54) PASSIVE WASTE HEAT REMOVAL SYSTEM ON SECONDARY SIDE OF MARINE ENVIRONMENTAL REACTOR

(71) Applicant: Shanghai Nuclear Engineering Research & Design Institute Co., LTD., Shanghai (CN)

(72) Inventors: Zhan LIU, Shanghai (CN); Haitao WANG, Shanghai (CN); Di LIU, Shanghai (CN); Bo YANG, Shanghai (CN); Kemei CAO, Shanghai (CN)

(21) Appl. No.: 17/996,286

(22) PCT Filed: Apr. 21, 2021
(86) PCT No.: PCT/CN2021/088574

§ 371 Date: Oct. 14, 2022

(30) Foreign Application Priority Data
Apr. 24, 2020 (CN) 202010333247.0

(51) Int. Cl. G21C 15/18

(52) U.S. Cl. CPC G21C 15/18

(57) ABSTRACT

A passive waste heat removal system on the secondary side of a marine environmental reactor. The system includes a containment, an airtight water tank, and a steam generator. The containment is partially or fully immersed in seawater. The airtight water tank is disposed on the inner wall surface of the containment, the airtight water tank being provided with a water tank inlet and a water tank outlet. The steam generator is placed in the containment, the steam generator having a steam outlet and a feedwater inlet. The water tank inlet of the airtight water tank communicates with the steam outlet of the steam generator by means of a first pipe, and the water tank outlet of the airtight water tank communicates with the feedwater inlet of the steam generator by means of a second pipe.

### TECHNICAL FIELD

The present invention relates to the technical field of reactor protection, and in particular to a marine type reactor secondary side passive residual heat removal system.

### BACKGROUND

With the development of industrialization process, the development of marine resources becomes more and more urgent. However, ocean development, especially the development of deep-sea resources, requires stable and large-capacity electric energy and thermal energy. Due to the particularity of environment and use, small-scale reactor (electric power less than 300 MW) nuclear energy system has become the most advantageous thermal and electric energy system in ocean development. Because the refueling cycle of small reactors is 2 years or longer, it can provide sufficient and reliable electricity and heat for a long time. It has a very good market prospect to load small nuclear power and heat supply stations on transport ships or mobile platforms to provide electricity and seawater desalination heat for the development of resources in different sea areas. In addition, the small-scale nuclear power system can also provide power for sea icebreakers and other ships.

Like large-scale nuclear steam supply systems, small-scale reactors also require to bring out fission heat release from the core through a steam generator for normal operation of the reactor. Steam from the steam generator flows to the turbine to do work through a top steam outlet, and water is fed through a feedwater inlet of the steam generator from a main feedwater pipe. Once the main feedwater loss accident occurs to the steam generator, the steam generator will have limited heat removal capacity, and the heat released from the core will be mismatched with the heat brought out by the steam generator. In such circumstance, if there is no effective heat removal system, the heat released from the reactor core could not be extracted, causing deterioration of the reactor core heating and even core meltdown.

In conventional nuclear power plants, an active secondary side residual heat removal system is used to bring out the core decay heat. This type of active system relies heavily on external power, and once the external power is not available, the core residual heat will not be continuously brought out. If there is no safety mitigation measures, the plant will eventually face a serious accident, even cause substantial radioactive release hazard. Usually, a residual heat removal system is equipped with shell-and-tube heat exchangers which are placed in a large water tank to extract heat from the core, which increases the complexity of the system equipment. In addition, too much equipment will occupy a large amount of space. When the nuclear steam supply system has strict requirements on the space, this system is not likely to meet such requirement.

After the Fukushima nuclear accident, more and more attention has been paid to passive technology for its safety, reliability and economy. It does not rely on external input (force, power or signal, manual operation) and its effect depends on natural physical laws (such as gravity, natural convection, heat conduction, etc.), inherent characteristics (such as material properties), or energy in the system (such as chemical reaction, decay heat, etc.). Therefore, it is of great significance and value for reactors to be equipped with a passive residual heat removal system.

### SUMMARY OF THE INVENTION

The present invention provides a marine type reactor secondary side passive residual heat removal system, which can continually bring out the heat of the reactor core and improve the safety of the system.

The marine type reactor secondary side passive residual heat removal system of the present invention comprises: a containment vessel partially or completely immersed in seawater; a closed water tank, which is arranged on an inner wall surface of the containment vessel, the closed water tank having a water tank inlet and a water tank outlet; and a steam generator which is disposed in the containment vessel and has a steam outlet and a feedwater inlet; wherein the water tank inlet of the closed water tank is communicated with the steam outlet of the steam generator through a first pipe, and the water tank outlet of the closed water tank is communicated with the feedwater inlet of the steam generator through a second pipe.

Preferably, the first pipe is provided with a first isolation valve, and the second pipe is provided with a second isolation valve.

Preferably, the first isolation valve and the second isolation valve are normally closed electric isolation valves.

Preferably, the first isolation valve and the second isolation valve are opened simultaneously after receiving the opening signal.

Preferably, before the first isolation valve is opened, the closed water tank is in a non-full water state.

Preferably, the closed water tank is provided with a safety valve.

Preferably, the water tank inlet is arranged at top of the closed water tank, and the water tank outlet is arranged at bottom of the closed water tank.

Preferably, the bottom elevation of the closed water tank is higher than the top elevation of the steam generator.

Preferably, when the containment vessel is in a swing state, an elevation of the lowest point at the bottom of the closed water tank is higher than an elevation of the highest point at top of the steam generator.

Preferably, the top elevation of the closed water tank is lower than the water surface elevation of the seawater.

Preferably, the containment vessel is a steel containment vessel.

The marine type reactor secondary side passive residual heat removal system of the present invention is arranged at the secondary side of the steam generator. It uses seawater to condense the steam in the closed water tank, drives the fluid to form natural circulation in the system depending on the fluid density difference, brings out the residual heat of the core, and uses seawater as the final heat sink to provide unlimited core cooling capacity. The marine type reactor secondary side passive residual heat removal system of the present invention adopts the passive safety design concept, does not rely on external driving force, greatly reduces the failure probability of the system and improves the safety of the system. Shell-and-tube heat exchanger widely used in the prior art is eliminated, so as to simplify the system equipment, meet the compact arrangement requirements of reactors in the marine environment, and improves the safety and economy of the system.

### BRIEF DESCRIPTION TO THE DRAWING

In order to more clearly illustrate the technical solution of the embodiments of the present application, the following will briefly introduce the drawings required for use in the embodiments of the present application, it is obvious to a person skilled in the art that the drawings described below are only some embodiments of the present application, and other drawings can be obtained according to the drawings without creative work.

FIG. 1 is a schematic diagram of a marine type reactor secondary side passive residual heat removal system according to an embodiment of the present invention.

In the drawings, the drawings are not drawn to the actual scale.

Reference Numbers

| | |
|---|---|
| 1: | containment vessel; |
| 2: | first pipe; |
| :3 | first osiolation valve; |
| 4: | closed water tank |
| 41: | water tank inlet; |
| 42: | water tank outlet; |
| 5: | second pipe; |
| 6: | second isolation valve; |
| 7: | steam generator; |
| 71: | steam outlet; |
| 72: | feedwater inlet; |
| 8: | safety valve |
| 100: | seawater |

### MODE OF CARRYING OUT THE INVENTION

The embodiments of the present application will be described in further detail with reference to the following drawings and embodiments. The following detailed description and drawings of the embodiments are used to illustrate the principles of the application, but they should not be used to limit the scope of the application, that is, the application is not limited to the described embodiments.

In the description of the present invention, unless otherwise stated, it should be understood that “multiple” means more than two, the directions or positional relationships indicated by the terms “upper”, “lower”, “left”, “right”, “inside” and “outside” are only for convenience and simplification of the description of this application, but do not indicate or imply that the referred devices or elements must have a specific orientation, or must be constructed and operated in a specific orientation. Therefore, it cannot be understood as a limitation of the present application. In addition, the terms “first”, “second”, “third” and the like are only used for illustrative purposes and cannot be understood as indicating or implying relative importance.

The terms of locality appearing in the following description are all directions shown in the drawing and are not intended to limit the specific structure of the present application. In the description of this application, it should also be noted that, unless otherwise specified and defined, the terms “install”, “communicate”, “connect” and “connecting” should be understood in a broad sense, for example, they can be fixed connections, detachable connections, or integral connections, and they can be direct connections or indirect connections through an intermediate medium. To a skilled person in the art, the specific meanings of the above terms in this application can be understood according to specific situations.

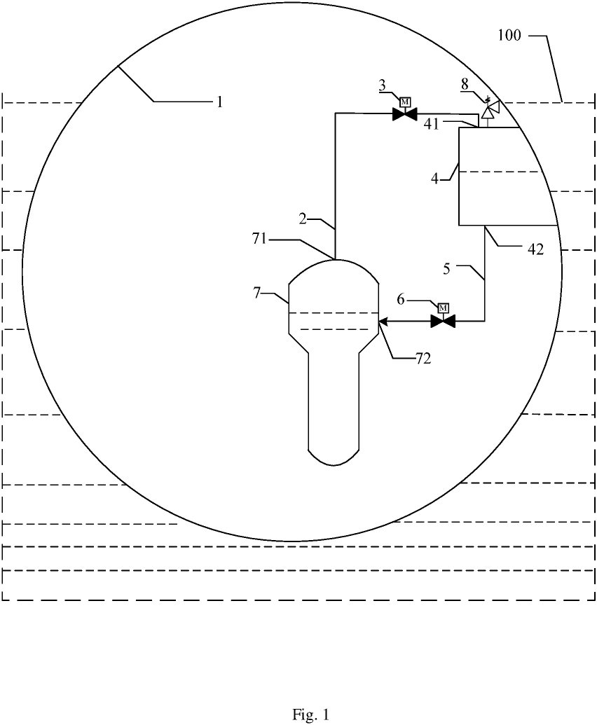

FIG. 1 is a schematic diagram of a marine type reactor secondary side passive residual heat removal system according to an embodiment of the present invention.

As shown in FIG. 1, the marine type reactor secondary side passive residual heat removal system of the present invention comprises a containment vessel 1, a closed water tank 4 and a steam generator 7, wherein the closed water tank 4 and the steam generator 7 are placed in the containment vessel 1. The containment vessel 1 is used to protect devices, such as the closed water tank 4 and the steam generator 7, from damages due to the environment, and to limit the release of potential radioactive gas in the containment vessel 1 to the outside after an accident.

The closed water tank 4 is provided on the inner wall surface of the containment vessel 1, and has a water tank inlet 41 and a water tank outlet 42. The closed water tank 4 being provided on the inner wall surface of the containment vessel 1 means that, one side plate of the closed water tank 4 is tightly fixed to the inner wall surface of the containment vessel 1, or the inner wall surface of the containment vessel 1 is used as one side plate of the closed water tank 4. The containment vessel 1 is partially or completely immersed in the seawater 100 so that the fluid in the closed water tank 4 can exchange heat with the seawater 100.

During operation of the reactor (not shown in the FIG. 1), heat generated from the fission of the reactor core needs to be brought out by the steam generator 7 to release the heat of the reactor. The steam generator 7 has a steam outlet 71 and a feedwater inlet 72. The steam generated from heat absorption by the steam generator 7 is discharged through the steam outlet 71. The feedwater inlet 72 is used to provide cooling water to the steam generator 7 for heat exchange.

The water tank inlet 41 of the closed water tank 4 is communicated with the steam outlet 71 of the steam generator 7 through a first pipe 2, and the water tank outlet 42 of the closed water tank 4 is communicated with the feedwater inlet 72 of the steam generator 7 through a second pipe 5. The steam generated by the steam generator 7 enters the closed water tank 4 through the first pipe 2, and is directly contacted with the inner wall of the closed water tank 4 and the liquid water in the closed water tank 4 to condense into liquid water. The heat of the fluid (including liquid water and steam) in the closed water tank 4 is conducted through the inner wall surface of the containment vessel 1 to the outer wall surface thereof, and exchanges heat with the seawater 100 to realize the extract of the reactor core heat. The liquid water in the closed water tank 4 flows back to the steam generator 7 through the second pipe 5 to avoid insufficient water supply in the steam generator 7.

The marine type reactor secondary side passive residual heat removal system of the present invention uses the wall of containment vessel 1 to efficiently exchange heat with seawater 100 so as to condense the steam in the closed water tank 4, drives the fluid to form natural circulation in the system depending on the fluid density difference, brings out the residual heat of the core, and uses seawater as the final heat sink to provide unlimited core cooling capacity.

In an embodiment of the present invention, the first pipe 2 is provided with a first isolation valve 3 for controlling opening and closing of conveying steam by the steam generator 7 to the closed water tank 4, and the second pipe 5 is provided with a second isolation valve 6 for controlling the closed water tank 4 to convey liquid water to the steam generator 7.

In an embodiment of the present invention, the first isolation valve 3 and the second isolation valve 6 are normally closed electric isolation valves. The marine type reactor secondary side passive residual heat removal system of the present invention is arranged on the secondary side of the steam generator 7. During normal operation of the reactor, the first isolation valve 3 and the second isolation valve 6 are closed, and the marine type reactor secondary side passive residual heat removal system of the present invention is in a standby state. At this time, steam from the steam generator 7 flows to the turbine (not shown in FIG. 1) to do work through a top steam outlet 71, and water is fed through the feedwater inlet 72 of the steam generator 7 from a main feedwater pipe (not shown in FIG. 1). These form a main discharge system. In case of an accident, once the main discharge system is unavailable, for example, when the main feedwater loss accident occurs, the first isolation valve 3 and the second isolation valve 6 will receive an opening signal, and the first isolation valve 3 and the second isolation valve 6 will be opened at the same time. At this time, the marine type reactor secondary side passive residual heat removal system of the present invention starts to operate. The first isolation valve 3 and the second isolation valve 6 are opened at the same time to ensure the normal operation of the system. The opening signal received by the first isolation valve 3 and the second isolation valve 6 may be a trigger signal sent after the liquid level detected by the liquid level detection mechanism in the steam generator 7 is lower than a preset value, or a trigger signal sent when the temperature of the primary circuit system of the reactor (not shown in FIG. 1) is higher than a preset value.

The first isolation valve 3 and the second isolation valve 6 are normally closed electric isolation valves. On one hand, it can ensure that the first isolation valve 3 and the second isolation valve 6 are normally closed during the normal operation of the reactor, on the other hand, the electric isolation valve can be used to set the opening speed of the isolation valve to facilitate the slow opening of the first isolation valve 3 and the second isolation valve 6, so as to prevent water hammer and facilitate the stable operation of the system.

In an embodiment of the present invention, before the first isolation valve 3 is opened, the closed water tank 4 is in a non-full water state. When the first isolation valve 3 is opened, the steam from the steam generator 7 will cause the water in the closed water tank 4 to evaporate and expand after encountering heat. At this time, the closed water tank 4 is not full of water and there is space in the closed water tank 4 to contain the expanded fluid.

In an embodiment of the present invention, the closed water tank 4 is provided with a safety valve 8 for overpressure protection of the closed water tank 4. When the pressure in the closed water tank 4 exceeds the preset pressure, the safety valve 8 is opened for decompression. The safety valve 8 may be provided at the top of the closed water tank 4.

In an embodiment of the present invention, the water tank inlet 41 is arranged at the top of the closed water tank 4, and the water tank outlet 42 is arranged at the bottom of the closed water tank 4. This arrangement can increase the density difference between cold and heat sources and increase the natural circulation capacity of the system.

In an embodiment of the present invention, the bottom elevation of the closed water tank 4 is higher than the top elevation of the steam generator 7, so that the liquid water in the closed water tank 4 can flow into the steam generator 7 under the action of gravity.

Further, when the containment vessel 1 is in a swing state, the elevation of the lowest point at the bottom of the closed water tank 4 is higher than the elevation of the highest point at the top of the steam generator 7. When the containment vessel 1 swings in the seawater 100, it is ensured that the liquid water in the closed water tank 4 can flow into the steam generator 7 under the action of gravity.

In an embodiment of the present invention, the elevation of the top of the closed water tank 4 is lower than the water surface elevation of the seawater 100, so that the fluid in the closed water tank 4 can always exchange heat with the seawater 100.

In an embodiment of the present invention, the containment vessel 1 is a steel containment vessel. The use of the steel containment vessel can improve the heat exchange coefficient of the containment vessel 1 and increase the heat exchange capacity between the fluid in the closed water tank 4 and the seawater 100.

In the marine type reactor secondary side passive residual heat removal system of the present invention, during normal operation of the reactor, the first isolation valve 3 and the second isolation valve 6 are closed, and the marine type reactor secondary side passive residual heat removal system of the present invention is in a standby state. In case of an accident, for example, when the main feedwater loss accident occurs, the first isolation valve 3 and the second isolation valve 6 will be opened at the same time after receiving an opening signal. At this time, the marine type reactor secondary side passive residual heat removal system of the present invention starts to operate. The steam generated by the steam generator 7 enters the closed water tank 4 through the first pipe 2, and is directly contacted with the inner wall of the closed water tank 4 and the liquid water in the closed water tank 4 to condense into liquid water. The heat of the fluid in the closed water tank 4 is conducted through the inner wall surface of the containment vessel 1 to the outer wall surface thereof, and exchanges heat with the seawater 100 to realize the extract of the reactor core heat. The liquid water in the closed water tank 4 flows back to the steam generator 7 through the second pipe 5 due to the difference in fluid density. During the accident, as the system continues to bring out heat and the decay heat of the core decreases, the heat removal capacity of the system will eventually match the decay heat of the core, and the reactor core will no longer have more serious accident. Due to the huge capacity of seawater, seawater can be used as the final heat sink to provide an indefinite cold source for the reactor core.

The marine type reactor secondary side passive residual heat removal system of the present invention is arranged at the secondary side of the steam generator 7. It uses seawater 100 to condense the steam in the closed water tank 4, drives the fluid to form natural circulation in the system depending on the fluid density difference, brings out the residual heat of the core, and uses seawater as the final heat sink to provide unlimited core cooling capacity. The marine type reactor secondary side passive residual heat removal system of the present invention adopts the passive safety design concept, does not rely on external driving force, greatly reduces the failure probability of the system and improves the safety of the system. Shell-and-tube heat exchanger widely used in the prior art is eliminated, so as to simplify the system equipment, meet the compact arrangement requirements of reactors in the marine environment, and improves the safety and economy of the system.

Although the present application has been described with reference to the preferred embodiments, various improvements may be made and parts thereof may be replaced with equivalents without departing from the scope of the present application. In particular, as long as there is no structural conflict, the technical features mentioned in each embodiment can be combined in any way. The present application is not limited to the specific embodiments disclosed herein, but includes all technical solutions falling within the scope of the claims.

1. A marine type reactor secondary side passive residual heat removal system, wherein the system comprises:
a containment vessel which is partially or completely immersed in seawater;
a closed water tank which is provided on an inner wall surface of the containment vessel and has a water tank inlet and a water tank outlet; and
a steam generator which is disposed in the containment vessel and has a steam outlet and a feedwater inlet;
wherein the water tank inlet of the closed water tank is communicated with the steam outlet of the steam generator through a first pipe, and the water tank outlet of the closed water tank is communicated with the feedwater inlet of the steam generator through a second pipe.

2. The marine type reactor secondary side passive residual heat removal system according to claim 1, wherein the first pipe is provided with a first isolation valve and the second pipe is provided with a second isolation valve.

3. The marine type reactor secondary side passive residual heat removal system according to claim 2, wherein the first isolation valve and the second isolation valve are normally closed electric isolation valves.

4. The marine type reactor secondary side passive residual heat removal system according to claim 2, wherein the first isolation valve and the second isolation valve are opened simultaneously after receiving an opening signal.

5. The marine type reactor secondary side passive residual heat removal system according to claim 2, wherein before the first isolation valve is opened, the closed water tank is in a non-full water state.

6. The marine type reactor secondary side passive residual heat removal system according to claim 1, wherein the closed water tank is provided with a safety valve.

7. The marine type reactor secondary side passive residual heat removal system according to claim 1, wherein the water tank inlet is arranged at top of the closed water tank, and the water tank outlet is arranged at bottom of the closed water tank.

8. The marine type reactor secondary side passive residual heat removal system according to claim 1, wherein bottom elevation of the closed water tank is higher than top elevation of the steam generator.

9. The marine type reactor secondary side passive residual heat removal system according to claim 8, wherein when the containment vessel is in a swing state, an elevation of the lowest point at bottom of the closed water tank is higher than an elevation of the highest point at top of the steam generator.

10. The marine type reactor secondary side passive residual heat removal system according to claim 1, wherein top elevation of the closed water tank is lower than water surface elevation of the seawater.

11. The marine type reactor secondary side passive residual heat removal system according to claim 1, wherein the containment vessel is a steel containment vessel.
